(19) United States
(12) Patent Application Publication
(10) Pub. No.: US 2011/0227829 A1
(43) Pub. Date: Sep. 22, 2011

(54) Keyboard for computer, word processor, or similar

(76) Inventor: Craig Barr, La Crescenta, CA (US)

(21) Appl. No.: 12/661,519

(22) Filed: Mar. 18, 2010

(51) Int. Cl. G06F 3/02

(52) U.S. Cl. 345/168

(57) ABSTRACT

A keyboard is especially configured for ease of use by inexperienced typists, or by the visually impaired, so that these people can more easily use computers and other devices using a keyboard. The improved keyboard includes a display which shows at least the last character typed. Thus, the inexperienced or visually impaired typist, who must look at the keys in a “hunt-and-peck” fashion, also sees in visual unity with the keys the most recently typed character. Importantly, the display is located immediately adjacent to and in visual unity with the most frequently used keys, so that the characters and words that have been most recently typed by the user are in the same visual field and are seen at the same time as the keys which the user is hunting for while typing.

### BACKGROUND OF THE INVENTION

1. Field of the Invention

This invention relates to an improved keyboard for a computer, word processor, or similar device, which allows the inexperienced typist (i.e., especially the hunt-and-peck typist) or the visually impaired typist who is less than expert, to visually select particular alphanumeric or punctuation keys, to depress those selected keys in a desired sequence so as to type desired words and phrases, and to visually verify on a visual display of the keyboard itself that the correct key selections and the correct sequence of depressing of those keys. This verification is allowed for a user of the keyboard by a visual display arranged in the keyboard immediately adjacent to the alphanumeric keys, and in the same visual field as these alphanumeric keys. Thus, the user need not shift visual focus from the keys to a monitor or flat panel display (i.e., attached to a host computer), for example, in order to periodically check to see whether the correct keys have been depressed in the correct sequence, and with the correct mode (i.e., caps, caps lock, and punctuation, for example).

2. Related Technology

The standard QWERTY keyboard in use on computers, word processors, and similar devices today is descended from the standard typewriter key arrangement developed in the 1860's by C. L. Sholes. Essentially, the typewriter keyboard was originally arranged by Sholes so that the most frequently used letters were placed as far apart as possible so as to prevent the typist from striking the keys more rapidly than the mechanical mechanism of early typewriters could accommodate. In other words, the standard keyboard arrangement was designed with the highly skilled, and very fast typist as the intended user. This standard typewriter keyboard, as indicated above, is commonly referred to as the QWERTY keyboard which letters designate the alphabetical sequence of the second row of keys from left to right. It has been uniformly stated that this keyboard seriously decreases the speed at which a typist can perform due to the antiquated arrangement of the keys. But, based on the way typing has been and still is taught, and based on the widespread availability of typewriters, computer keyboards, and similar devices (e.g., television based internet access devices) using this format, the QWERTY keyboard is still in almost universal use.

It is, of course, obvious that in today's technical society, the mechanical constraints of antiquated typewriters have been completely overcome, but the keyboard is still widely employed even though it was deliberately designed to reduce the speed of data input so that highly skilled and speedy typists couldn't overcome the mechanical limitations of the day's mechanical typewriters. But, because of human user considerations and the very great number of people who are familiar with and use only a QWERTY keyboard, the use of this arrangement continues. However, for a very great number of today's computer users, most of whom are neither highly skilled or speedy typists, the standard QWERTY keyboard presents many challenges.

Many people are cognizant of these problems, and over the course of time several improved keyboard arrangements have been developed and are widely known such as the Dvorak arrangement, the Montgomery arrangement, as well as various different arrangements. Essentially, these “improved” keyboards have the alphanumeric characters prearranged to afford substantial improvement in terms of speed, accuracy of keyboard entry, and intuitive arrangement of the keys. The proponents of such systems are many, and a great deal of literature exists in the related technology extolling the virtues of alternate keyboard systems using such key arrangements. See, for example, an article entitled “Bringing Manual Input into the Twentieth Century-New Keyboard Concepts” published in Computer (IEEE, Mar. 3, 1982 by E. B. Montgomery). See also, an article entitled “Will There Ever be an Efficient Keyboard” published in High Technology, January 1983 by Cary Lu. Essentially, such articles, as well as many other references, recognize the need for improving the keyboard format to gain increased speed and efficiency. In spite of such considerations, the improved keyboard arrangements have not been widely accepted. A major reason for this is that the QWERTY keyboard arrangement is presently inflexible as existing typewriters have designated labeling on the key tops, and therefore, can only support the antiquated key configuration.

Unfortunately, the un-skilled computer user, and the users who are visually impaired (and possibly un-skilled as well) are essentially not considered by the efforts in the related technology to improve use of typewriters, word processors, computers, and similar devices by improving the keyboard. That is, as computers have become increasingly widespread and available to the public, and with the use of e-mail becoming also much more common, more and more people find it necessary or convenient to use a computer, or possibly an electronic typewriter, word processor, or television-based interne access device, to send and receive correspondence from friends and relatives, as well as to do other tasks, such as book keeping or accounting. But, many of these people are not skilled typists. Many have never had a typing class in their entire lives. So, many if not most current users of computers, especially of home computers, are unskilled typists. Many of these unskilled typists use essentially the “hunt-and-peck” method of typing. In such a method, the user looks mostly at the keyboard, selected the next key or keys to be depressed, and depresses these keys (or next key) while continuing to look at the keyboard. Thus, the user must periodically look away from the keyboard and at a CRT monitor or flat panel display, for example, in order to see and verify what has actually been typed. With each change of view between the keyboard and the monitor, the user's eyes must change focus. Thus, typing speed is very slow, accuracy is questionable, corrections are slow and laborious to make, and fatigue arrives very soon, especially visual fatigue. That is, eye strain is a frequent complaint for unskilled typists from looking back and forth between the keyboard and monitor.

It is, therefore, an object of the present invention to provide a keyboard for a computer, typewriter or similar device which presents at least the alphabetic keys and a display device displaying at least a significant portion of the most recently typed words, phrases, and characters, in a common visual field for the user.

### SUMMARY OF THE INVENTION

A keyboard apparatus for allowing a user to select any one of a predetermined number of keyboard arrangements to enable the entry of alphanumeric data said keyboard comprising a plurality of fixed input keys arranged in rows and columns according to a standard typewriter keyboard format, separate indicating areas, each one associated with one of said keys and positioned proximate to each key in said format for selectively displaying a proper symbol associated with said key and indicative of a character to be provided by said key according to said selected arrangements, selector means associated with said indicating areas and capable of selecting any one of said predetermined number of arrangements to cause each indicating area to display that symbol associated with that character to be furnished by said key according to said selected arrangement.

### BRIEF DESCRIPTION OF THE DRAWING FIGURES

FIG. 1 provides a plan view of a QWERTY keyboard embodying this present invention;

FIG. 2 is a side elevation view of the keyboard seen in FIG. 1; and

FIG. 3 provides a schematic and diagrammatic view of a circuit arrangement for implementing the keyboard of the present invention.

### BRIEF DESCRIPTION OF A PREFERRED EXEMPLARY EMBODIMENT OF THE INVENTION

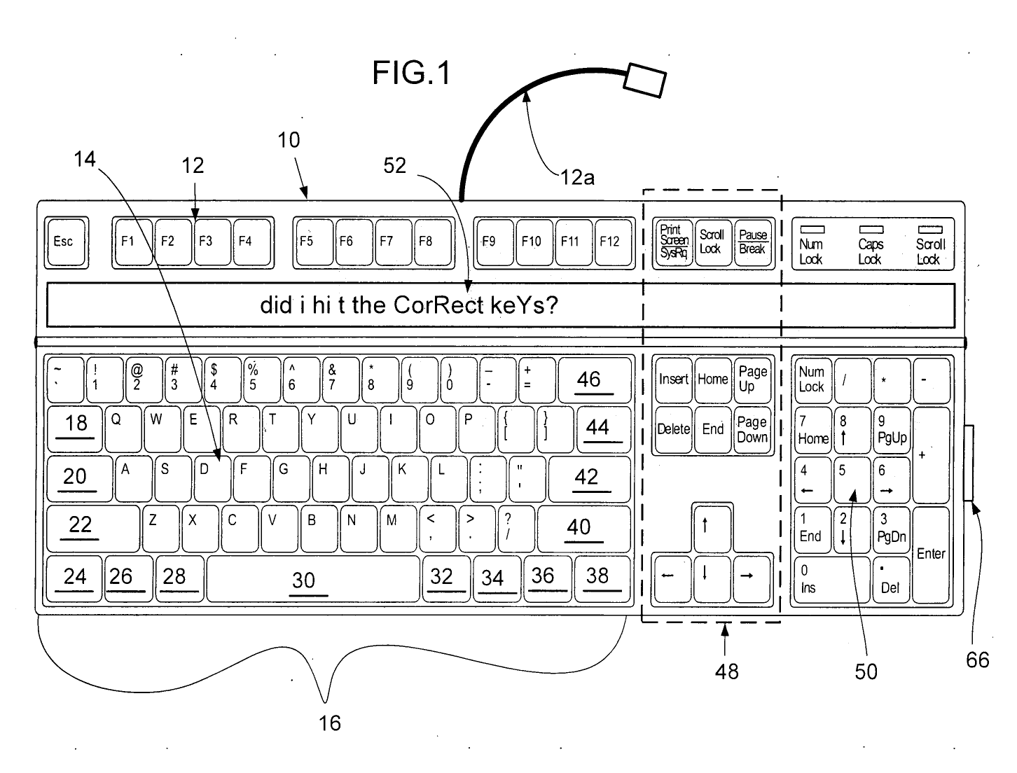

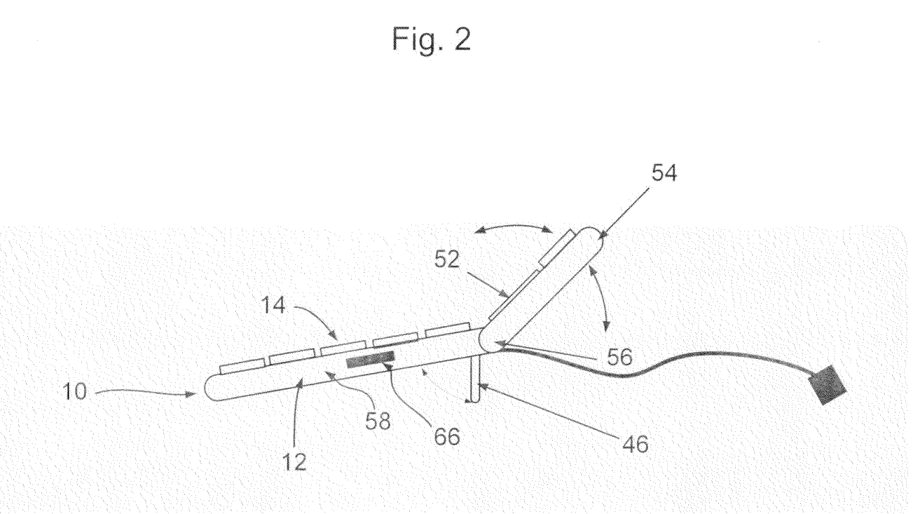

Referring to FIGS. 1 and 2 in conjunction, and with attention first particularly to FIG. 1, top or plan view of a QWERTY keyboard 10 is shown. This keyboard 10 includes a base or housing 12 carrying an array or matrix 14 of keys generally arranged in rows and columns. The keyboard 10 interfaces with a host computer (not seen in the drawing Figures) via a connector cable and plug, generally indicated with the numeral 12a. Those ordinarily skilled in the pertinent arts will understand that the interface 12a may be effected via a PS/2 cable and plug, via a USB cable, or by conventional wireless connections, such as by infrared, or radio frequency connection. The array 14 (or key matrix) includes a main array 16 of keys, which main array includes the alpha-numeric, punctuation, and symbol keys, as well as the control keys. The keys of main array 16 include the alphabetic keys for A-Z, and across the top of the alphabetic keys in a row of 13 keys the numeric keys for 1-0 (which row also include commonly used symbols and punctuation marks). The main array 16 also includes 14 control keys, such as keys indicated with reference numerals 18-44, respectively for “tab,” “caps lock,” “shift,” “control,” “windows control hot'key,” “alt,” “space,” “alt,” “windows control hot key,” “right mouse button input,” “control,” “shift”, “enter,” and “backspace.” The illustrated keyboard is seen to be a “windows” type of computer keyboard, although the invention is not so limited. Essentially, as one can see, the keyboard contains four rows of keys with the top row having 14 keys and containing numeric, punctuation, and symbol keys. The second row has 14 keys, including the “tab” key at the left end, and an “enter” key at the right end, with the sequence of alphabetic characters in this letter row indicating why the keyboard is called QWERTY when viewing this second row of keys from left to right. The third row has 13 keys with a “caps lock” key at the left end, and an “enter” key at the right end. The alphabetic keys run “a, s, d, f, g, h, j, k, and l, from left to right, followed by two punctuation keys. Finally, the fourth row of keys includes a “shift” key at each end of this row, and includes the rest of the alphabet (i.e., “z, x, c, v, b, n, and m”) in standard arrangement of the keys for a QWERTY keyboard, along with 3 punctuation keys as the right end of this row. The very bottom row of keys are all control keys which have been pointed out above. As is seen best in FIG. 2, the keyboard includes adjustable supports 46 which my be extended in order to present the keys of array 16 in a most advantageous view for a user.

To the right of the main array 16, the keyboard 10 includes typing control keys in an array 48, and to the right of this typing control array 48, an array 50 of numeric keys. Finally, above the array 16, and separated from this array by a larger than common spacing, is a row of computer command keys. These computer command keys include an “Escape” key, and keys F1 through F12, which are not used in typing and in fact are seldom or never used by most computer users.

As indicated in the Background of the Invention, the essential arrangement of the keys on the keyboard 10 was developed by the inventor Sholes so that operation was deliberately slowed down to prevent mechanical difficulty while typing was carried out by skilled and speedy typists of the day. However, this basic keyboard arrangement has presented no end of problems and obstacles for the unskilled and even for intermediately skilled typists ever since. Further, as can be seen from the above, the utilization of the historic keyboard configuration as a computer input device has added considerably to the complexity and difficulty of use of this keyboard arrangement, especially for the un-skilled user. Nevertheless, as indicated, this is the keyboard utilized today on “windows” computers and in standard typewriters, and for other applications such as television-based interne access devices. Other computer operating systems, such as Macintosh or Apple, have similarly complex keyboards, most also based on the QWERTY architecture.

Continuing with a consideration of FIG. 1, it is seen again that the keyboard includes a row of computer function control or access keys “Escape” and F1 through F12. This row also includes 3 keys of the array 48. And according to the present invention, the top row of keys is spaced from the remaining keys by an distance sufficient to allow a display apparatus 52 to be interposed. On this display apparatus 52 are shown a number of recently-typed characters. In other words, a user of the keyboard 10 has typed in a test message, “did i hi t the CoRrect keys?”. The association and operation of the display apparatus 52 is further explained below. Further, viewing now FIG. 2, it is seen that the display apparatus 52, as well as the top row of keys identified above, are both carried on an upper and relatively hinged portion 54 of the keyboard 10. The portion 54 is hinged at 56, best seen in FIG. 2, and this hinge feature is provided with a friction hold device, or with a selective detent device, allowing a user of the keyboard to select a pivotal position of the display 52 relative to the array of keys 16 in particular. As is indicated on FIG. 1, the display 52 is interfaced with the keys of keyboard 10 such that the alphanumeric, and punctuation symbols are displayed much as they would be displayed by a word processing program running on the computer to which this keyboard is connected. However, such a word processing program will be displaying its output on a CRT monitor, or on a flat-panel display, which is out of the visual field of a user looking at the keys of array 16 on keyboard 10. That is, while typing, and in order to verify that the desired keys have been selected and pressed in the proper and desired sequence, a user of a computer word processing program, for example, would have to shift their visual field from the array 16 of keys, and to the CRT or flat-panel display. Then the user has to shift their visual field back to the keyboard in order to either continue typing, or to correct the errors in their recent work.

However, as is seen best in FIG. 1, a user of the keyboard 10 is presented in substantially the same visual field as the array 16 of keys with a visual display (i.e., on display apparatus 52) of the most recent words, characters, and punctuation symbols typed by the user. The display 52 is most preferably driven directly from the keyboard 10 itself and is not dependent upon the program or programs running on the computer to which the keyboard is attached. In other words, the display 52 will display the most recent letters, numbers, characters and punctuations typed into, for example, a database management, or spreadsheet program; as well as the most recent word-processing characters as illustrated by FIG. 1. By adjustments of the inclination of the main part of the keyboard, which is provided by adjustable supports 46 best seen in FIG. 2, and then a corresponding pivotal adjustment of the portion 54 carrying the visual display apparatus 52, the user can place the keys of array 16 substantially in the same visual field (i.e., substantially at the same focal distance from the user's eyes) as the display apparatus 52. So, the user can see the keys of array 16 and the characters, letters, and punctuation shown on display apparatus 52 all at the same time and without having to repeatedly shift visual focus between a keyboard and a CRT or flat-panel display of a computer system. For the unskilled typist, both speed and accuracy are improved by use of the keyboard 10, while visual fatigue is reduced.

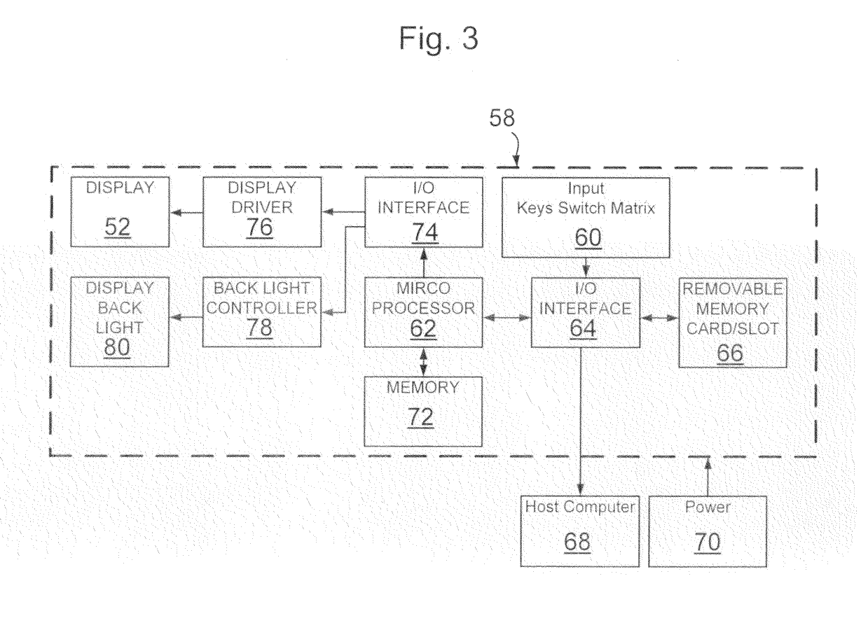

Turning now to FIG. 3, a preferred exemplary embodiment of a circuit 58 within the keyboard 10 is presented in schematic and diagrammatic form. Although the keyboard 10 is not limited to this particular circuit schematic, and other circuit arrangements may be utilized (i.e., such as an application specific integrated circuit—ASIC) the functions of keyboard 10 will be supported by the circuit 58. Considering circuit 58, it is seen that the array of keys, including keys 16, 18-44, 48, and 50 is represented as a key matrix 60. These keys communicate with a processor 62 via an input/output (I/O) interface 64. The I/O interface 64 also provides for the processor 62 to communicate both with a removable memory card dock 66. As is indicated by arrowed numeral 68, the I/O 64 also provides for communication with a host computer. At arrowed numeral 70 is indicated that power is received by the circuit 58, and this power may be provided alternatively by the host computer (i.e., via PS/2 or USB connection, for example), or may be provided by batteries resident on the keyboard 10. In other words, the interface with the host computer may be infrared or wireless, for example, rather than over a PS/2 or USB connection cable. The processor 62 has interface with a memory 72 which may include, for example, a look-up table of codes to be communicated with the host computer in response to each key press (or combination of key presses) effected by a user on the key matrix 60. Also, the memory 72 may be utilized to store data or information or programming downloaded into the keyboard via memory card dock 66, so that, for example, the keyboard may be configured if desired to a configuration other than QWERTY.

Finally, the circuit 58 also includes in I/O 74 by which the processor has communication with a display driver 76 (i.e., driving display 52) and with a back light controller 78 which determines the light output of a back light 80. The back light 80 controls and effects the illumination of the display 52 so that the user can select a level of illumination and visibility for the display 52 making the display 52 have a selected level and degree of visibility for the user. In this way, while looking at the key matrix, and especially at the array 16 of keys mainly used for typing, the user of the keyboard 10 can effectively see not only the array 16 of keys, but also the display 52, and the characters on this display, which are the most recently typed letters; numbers, punctuation, or other characters that the user has selected by pressing keys on the keyboard 10.

Of course, it will be understood that the keyboard 10 can be used as well by a skilled and/or speedy typist. The skilled typist will seldom if ever look at the keys on the keyboard. Thus, the skilled typist will not need, but may utilize the characters displayed on display apparatus 52 in order to verify the accuracy of the typing. On the other hand, the unskilled typist, the hunt-and-peck typist, or the “two fingers” typist, who almost continually looks at the keys in order to type will benefit greatly by use of the keyboard 10. This is the case, because these unskilled typists will be able to see not only the most frequently used typing keys, but the display 52 and characters shown thereon, all in the same visual field, and all substantially at the same focal distance. Recalling the test message typed into the keyboard 10 as seen in FIG. 1, it is apparent that the typist has made many errors. But, the present inventive keyboard allows the unskilled typist to quickly see the recently-typed characters in a visual unity with the array 16 of keys, and to thus catch and correct errors quickly and will reduced eye strain. As depicted in FIG. 1, the most recent typed character (i.e., the question mark “?”) appears near the center of display apparatus 52 so that it is in a visual unity with the keys 16. As successive characters are typed, the characters advance from right to left, with the left-most character disappearing off the left end of the display as each successive new character is typed by a user. However, this particular mode of display operation is simply most preferred, but not limiting. In other words, a user of the keyboard 10 who prefers, for example, to have the last character typed appear further to the right (or further to the left) along display apparatus 52 may accomplish this adjustment in the operation of the keyboard 10 by utilizing control functions built into the circuit 58 and accessed, for example, via the computer control keys or via a downloaded control sub-routine entered via memory card slot 66. In overview; an improved keyboard according to this invention provides visual unity between at least the main array of typing keys and characters shown on the visual display 52, allowing an unskilled typist to achieve greater speed, reduced errors, and the ability to visually check their typing with a great reduction in eye strain and fatigue. So, the unskilled typists will not be required to continually shift their view from the keys to a monitor and back and forth, and repeatedly back and forth while typing. So to, both typing speed and accuracy will be improved for unskilled typists, while eye strain and fatigue are reduced. Further, the keyboard 10, because it assists unskilled typists to use a computer and word processor, it may encourage the unskilled to persevere and become more proficient, and may assist as a training aid toward unskilled typists becoming more skilled.

It will be understood in view of the above that the present invention is not limited to any particular arrangement of the keys. That is, the present invention is certainly not limited to use in keyboards having only the QWERTY arrangement of the keys, and can be employed in keyboards, having other key arrangements. Further, the present invention is not limited by the particular preferred embodiment utilized to illustrate by example the principles and advantages of this invention. Such example implies no limitation on the invention, and no such limitation is to be inferred. Rather the invention is intended to be limited only by the scope and spirit of the appended claims, which also provide a definition of the invention.

I claim:

1. An improved keyboard apparatus for a computer or similar device, and for allowing a user to view both the most frequently utilized alphabetic keys and a display device presenting at least a significant portion of one line of the most recently typed characters and words both in the same visual field for the user; thus better allowing an inexperienced or visually impaired user to entry of alphabetic data via said keyboard, said improved keyboard apparatus comprising:
a plurality of alphabetic input keys arranged in an array of plural rows and columns according to a selected typewriter keyboard format so as to present to a user a complete alphabet;
immediately adjacent to and in a common visual field for the user a display apparatus presenting to the user at least the most recently typed character;
whereby, said alphabetic keys and said display of the most recently typed character are presented in a common visual field to the user, allowing the user to visually select alphabetic keys, depress the selected keys in the desired sequence, and visually verify on said display that the correct keys have been depressed in the correct sequence without the need to change the user's visual field from the keyboard.

2. The improved keyboard apparatus of claim 1 wherein said display apparatus displays a significant portion of one line of typing, so as to display the most recently typed words and characters.

3. The improved keyboard apparatus of claim 1 wherein said display apparatus is disposed immediately above said alphabetic keys.

4. The improved keyboard apparatus of claim 1 wherein said keyboard apparatus also includes a row of computer function control keys, said row of computer function control keys being spaced apart from and above said array of alphabetic keys, and said display apparatus is disposed intermediate to and between said array of alphabetic keys and below said row of computer function control keys.

5. The improved keyboard apparatus of claim 1 wherein said keyboard includes a row of numeric keys, said row of numeric keys being arrayed immediately above said array of alphabetic keys, and said display apparatus is disposed immediately above said numeric keys.

6. The improved keyboard apparatus of claim 1 wherein said keyboard further includes a base portion carrying said array of alphabetic keys, and a relatively hinged portion also carried by said base portion and selectively pivotal relative thereto in order to be moved to and hold a selected pivotal position relative to said base portion, said relatively hinged portion carrying said display apparatus, whereby a user of said keyboard may dispose said base portion of best viewing of said alphabetic keys at a selected focal distance, and may further pivotally position said relatively hinged portion so that said display apparatus is also viewed in a common visual field along with said alphabetic keys and at substantially said selected focal distance for said user.

7. An improved keyboard and display apparatus for a computer or similar device, said apparatus providing to a user a view of alphanumeric and punctuation keys for typing, and of a display device driven by said keyboard and displaying several of the most recently typed alphanumeric or punctuation characters, both in the same visual field and substantially at the same focal distance to provide visual unity for the user; said improved keyboard comprising:
a plurality of alphanumeric and punctuation input keys arranged in an array of plural rows and columns according to a selected typewriter keyboard format so as to present to a user a complete alphabet, numbers from 0 to 9, and punctuation characters;
said array of plural rows and columns of input keys being in a visual field and at a selected focal distance for said user;
a display apparatus driven by said input keys and displaying several of the most recently typed characters;
said display apparatus also being in said visual field for the user, and substantially at said selected focal distance;
whereby, said alphanumeric keys, said punctuation keys, and said display are all presented to said user in said visual field and substantially at a common focal distance so that said alphanumeric keys, said punctuation keys, and said display are all visible and in focus to said user in visual unity substantially simultaneously and without the need for said user to shift visual field or focus distance while typing.

8. The improved keyboard and display apparatus of claim 7 wherein said keyboard further includes a base portion carrying said array of alphanumeric and punctuation keys, and a relatively hinged portion also carried by said base portion and selectively pivotal relative thereto in order to be moved to and hold a selected pivotal position relative to said base portion, said relatively hinged portion carrying said display apparatus, whereby a user of said keyboard may dispose said base portion for best viewing of said alphanumeric and punctuation keys at a selected focal distance, and may further pivotally position said relatively hinged portion so that said display apparatus is also viewed in a common visual field along with said alphabetic keys and at substantially said selected focal distance for said user.

9. The improved keyboard and display apparatus of claim 7 wherein said keyboard also includes a row of computer function control keys, said row of computer function control keys being spaced apart from and above said array of alphanumeric and punctuation keys, and said display apparatus is disposed intermediate to and between said array of alphanumeric and punctuation keys and below said row of computer function control keys.

10. A method for providing to a user of a keyboard in visual unity a view of alphanumeric and punctuation keys for typing, simultaneously with a view of a display device driven by said keyboard and displaying at least the most recently typed character, said method comprising:
providing said keyboard with a base carrying a plurality of alphanumeric and punctuation input keys arranged in an array of plural rows and columns according to a selected typewriter keyboard format;
disposing said base so as to present to a user of the keyboard said array of plural rows and columns of alphanumeric and punctuation input keys in a visual field and at a selected focal distance for said user;
providing said keyboard with a display portion hingedly carried pivotally by said base, and providing on said display portion a display apparatus driven by said input keys and displaying the most recently typed character;
providing for said display portion to be selectively pivoted by said user into a selected position in which said display apparatus is also in said visual field for the user, and substantially at said selected focal distance;
whereby, said alphanumeric keys, said punctuation keys, and said display are all presented to said user in visual unity in a common visual field and substantially at a common focal distance so that said alphanumeric keys, said punctuation keys, and said display are all visible and in focus to said user substantially simultaneously and without the need for said user to shift visual field or focus distance while typing in order to view the most recently typed character.

11. The method of claim 10 further including the step of providing on said apparatus portion a significant portion of one line of typing, so as to display the most recently typed words and characters in visual unity for a user.

12. The method of claim 10 further including the step of providing variable illumination of said display portion, and allowing a user of said keyboard to increase or decrease the level of said variable illumination of said display portion in order for said user to better achieve a visual unity among the keys of said array of plural alphanumeric keys and said most recently typed characters displayed on said display portion.

13. An improved user interface and input apparatus configured as a keyboard for a computer or similar device, said apparatus comprising:
a plurality of alphanumeric input keys arranged in an array of plural rows and columns according to a selected typewriter keyboard format so as to present to a user a complete alphabet;
immediately adjacent to and in a common visual field for the user a display apparatus presenting to the user at least a significant portion of one line of typing, so as to display the most recently typed words and characters;
a processor receiving from said alphanumeric keys indications of key activations effected by a user of said keyboard;
a processor and memory, said processor accessing said memory in order to acquire code information corresponding to particular key activations effected by said user, and providing said code information to a host computer;
a display driver also receiving from said processor a typing character to be displayed on said display apparatus and corresponding to said key activations effected by said user so that said display apparatus shows the most recently typed words and characters typed by a user of said keyboard in a common visual field for the user.

14. The improved user interface apparatus of claim 13 further disposing said display apparatus immediately above said alphanumeric key array.

15. The improved user interface apparatus of claim 13 wherein said apparatus also includes a memory card dock, and in input/output circuit allowing information and data from a memory card inserted into said memory card dock to be accessed by said processor.

16. The improved user interface apparatus of claim 13 wherein said apparatus includes a row of computer function control keys, said row of computer function control keys being arrayed above said array of alphanumeric keys and spaced there from to define a determined distance space, and said display apparatus being disposed immediately above said alphanumeric keys and within said determined distance space.

17. The improved user input apparatus of claim 16 wherein said apparatus further includes a base portion carrying said array of alphanumeric keys, and a relatively hinged portion also carried by said base portion and selectively pivotal relative thereto in order to be moved to and hold a selected pivotal position relative to said base portion, said relatively hinged portion carrying adjacent to an upper extent thereof said row of computer function control keys, and said relatively hinged portion also carrying adjacent to a lower extent thereof and in said determined distance space said display apparatus.
